(19) United States
(12) Patent Application Publication
(10) Pub. No.: US 2004/0221286 A1
(43) Pub. Date: Nov. 4, 2004

(54) Method, system, and storage medium for performing synchronous quality function deployment over a computer network

(76) Inventors: Mohamed Ahmed Ali, Clifton Park, NY (US); Michael Christopher Hetz, Malta, NY (US)

Correspondence Address: GENERAL ELECTRIC COMPANY, GLOBAL RESEARCH, PATENT DOCKET RM. BLDG. K1-4A59, NISKAYUNA, NY, 12309, US

(21) Appl. No.: 10/065,479

(22) Filed: Oct. 22, 2002

(51) Int. Cl. G06F 15/16

(52) U.S. Cl. 718/100; 709/203; 709/227

(57) ABSTRACT

An exemplary embodiment of the invention relates to a method, system, and storage medium for performing synchronous quality function deployment (QFD) over a computer network. The computer network includes a real-time server, a lightweight thin client server, a data storage device, and at least two client systems. The system comprises a QFD tool including: a ‘Create New QFD session’ component; an ‘Active QFD session’ component; a ‘Finished QFD session’ component; and a ‘Scheduled QFD session’ component. The lightweight thin client server executes the QFD tool and the client systems access the QFD tool in real time via the real-time server. The ‘Create New QFD session’ component includes instructions for establishing a new QFD session by a user. The ‘Active QFD session’ component includes a listing of QFD sessions that are in progress. The ‘Finished QFD session’ component enables a user to resurrect a completed QFD session. The ‘Scheduled QFD session’ component enables a user to view all scheduled QFD sessions. The invention also includes a method and a storage medium.

### BACKGROUND OF INVENTION

The present invention relates generally to quality function deployment (QFD) and in particular, to a method, system, and storage medium for performing synchronous quality function deployment over a computer network.

Design for six sigma (DFSS) is a data driven methodology for improving the quality of products and services delivered to customers. For any process (business, manufacturing, service, etc.) the sigma value is a metric that indicates how well the process is performing—the higher the sigma value, the better the output. Sigma measures the capability of the process to perform defect-free work, where a defect is synonymous with customer dissatisfaction. A common measurement index is ‘defects-per-unit’ where a unit can be virtually anything—a component, a part of an engine, an administrative procedure, etc. The DFSS process utilizes a variety of quality concepts including defining critical to quality (CTQ) parameters, or CTQs. The CTQs identify features of the product that should be present in order to meet customer requirements. A number of key control parameters (KCPs) are identified as having an effect on the CTQs. KCPs are those variables that need to be controlled in order to meet the CTQs. For example, key control parameters for a diesel engine may include compression ratio, manifold air pressure and temperature. To monitor quality of a product, the values of the key control parameters are evaluated against actual values/measurements to confirm that the product is operating under ideal conditions. Once the product is defined, the CTQs are verified at all levels (component, assembly, sub-system and system).

Each element of a system has its own list of CTQs upon which the performance of the element as part of the system can be gauged. The values of the CTQs at a first level (e.g., the system level) may depend on the values of the CTQs at subsequent levels (e.g., sub-system and component levels).

Methods have been developed to define CTQs at various system levels so that the overall system CTQs can be met. Quality Function Deployment (QFD) is a known process for identifying CTQs and flowing them down to subsequent levels. QFD methods allow specific customer requirements to be documented and broken down into manageable and actionable details. The relationship between each level CTQs and key control parameters (KCPs) have been referred to as a house of quality. Each house of quality corresponds to a stage or level of the process of designing a product. At each level, the CTQs are identified and their relations to the higher level CTQs are specified qualitatively by high (designated h), medium (designated m), or low (designated l), depending on the relation strength.

One known method of QFD provides quality matrices each of which focus on a certain element of a system while maintaining their common systemic grounds which stem from sharing the same CTQs at the higher-level quality matrix. FIGS. 1 and 2 illustrate an arrangement of quality matrices. At a first level, a system quality matrix 100 relates CTQs 102 to KCPs 104. At the intersection of a CTQ 102 and KCP 104, an interaction weight 106 may be entered representing qualitatively how the KCP affects the CTQ. The interaction weights 106 can be used to derive a quantitative measure of how a KCP influences a CTQ as measured in terms of ‘high’, ‘medium’, and ‘low’, where ‘high’ reflects a substantial effect on a CTQ.

KCPs 104 are arranged in a plurality of groups 110, 112 and 114. Each group of KCPs corresponds to a subsystem. A second level quality matrix is formed for each of the groups of KCPs. For example, as shown in FIG. 1, the first level KCPs in group 110 are used as the CTQs 202 in second level quality matrix 200. The second level quality matrix 200 is similar to the first level quality matrix 100 in that the CTQs 202 are related to KCPs 204 through interaction weights 206. Third and subsequent levels of quality matrices may be utilized as necessary.

The relation between CTQs and KCPs can be described quantitatively through the use of transfer functions. For example, the system level CTQ of image quality is defined as a function of lamp brightness, lamp focal spot and lens clarity. The transfer functions can be used in the framework of QFD by replacing the high, medium, and low interaction weights with a mathematical sensitivity of each dependent CTQ to each KCP. The mathematical sensitivity is a quantitative value based on the transfer function and may correspond to the partial derivative of the transfer function relating the CTQ to the KCPs.

While existing QFD methods are useful, it is understood that improvements to QFD are desirable.

### SUMMARY OF INVENTION

An exemplary embodiment of the invention relates to a method, system, and storage medium for performing synchronous quality function deployment (QFD) over a computer network. The computer network includes a real-time server, a lightweight thin client server, a data storage device, and at least two client systems. The system comprises a QFD tool including: a Create New QFD session component; an Active QFD session component; a Finished QFD session component; and a Scheduled QFD session component. The lightweight server executes the QFD tool and the client systems access the QFD tool in real time via the real-time server. The Create New QFD session component includes instructions for establishing a new QFD session by a user. The Active QFD session component includes a listing of QFD sessions that are in progress. The Finished QFD session component enables a user to resurrect a completed QFD session. The Scheduled QFD session component enables a user to view all scheduled QFD sessions. The invention also includes a method and a storage medium.

Further aspects of the invention are disclosed herein. The above discussed and other features and advantages of the present invention will be appreciated and understood by those skilled in the art from the following detailed description and drawings.

### BRIEF DESCRIPTION OF DRAWINGS

Referring to the exemplary drawings wherein like elements are numbered alike in the several FIGURES:

FIG. 1 is a diagram representing a high level house of quality and QFD values for a system;

FIG. 2 is a diagram representing a lower level house of quality and QFD values for a subsystem of FIG. 1;

FIG. 3 is an exemplary computer screen window illustrating a sample main menu as seen by a user upon logging onto the QFD tool;

FIG. 4 is an exemplary computer screen window illustrating the Create New QFD Session component as seen by a user of the QFD tool;

FIG. 5 is an exemplary computer screen window illustrating the Scheduled QFD Sessions component as seen by a user of the QFD tool;

FIG. 6 is a flowchart illustrating a process for participating in an active QFD session;

FIG. 7 is an exemplary computer screen window illustrating an active QFD session in progress as seen by a session facilitator; and

FIG. 8 is an exemplary block diagram of a system for implementing the QFD tool.

### DETAILED DESCRIPTION

An exemplary embodiment of the present invention is a method, system, and storage medium for performing synchronous quality function deployment (QFD) over a computer network. The QFD tool of the invention may be performed utilizing real-time server technology such as IBM's Sametime™ server. Other tools such as E-Matrix software by MatrixOne, Inc. and Java Shared Data Toolkit™ (JSDTK) may be used to implement the invention. The QFD tool may be developed as an applet executing on a lightweight or thin-client server for communicating with users (also referred to as client systems) and the real-time server. A secure network architecture is desirable for protecting the business entity's information from outside or unauthorized entities. Typical users of the QFD tool include business employees, management personnel, customers, supplier entities, etc.

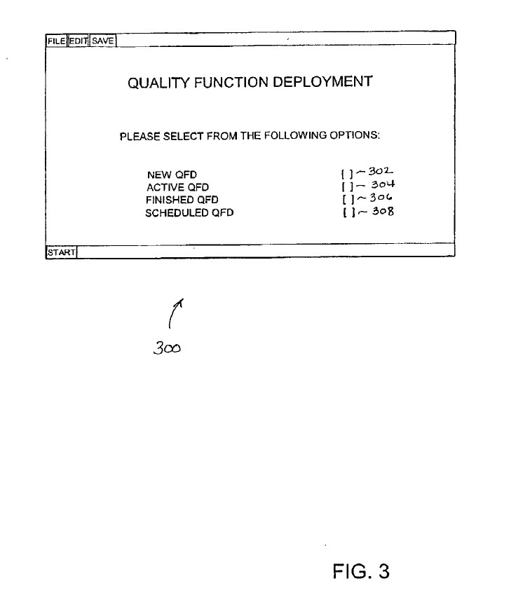

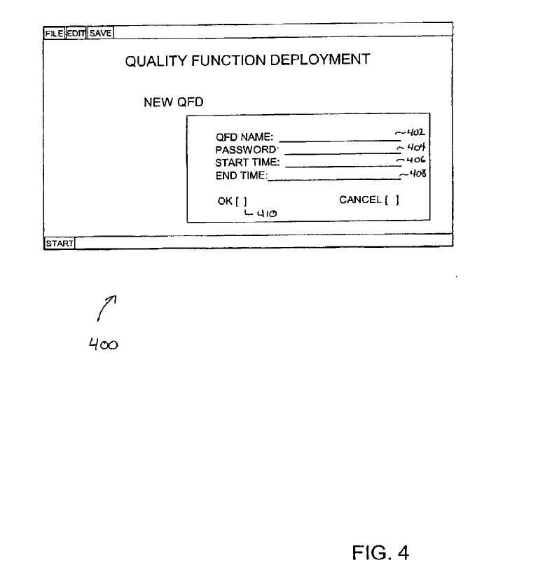

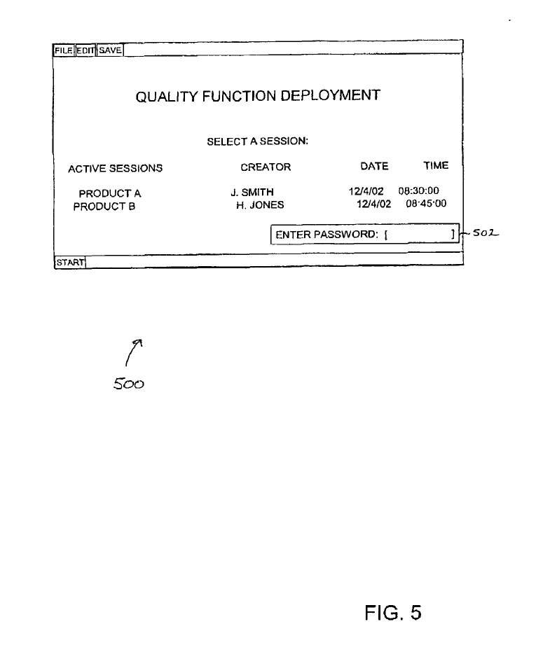

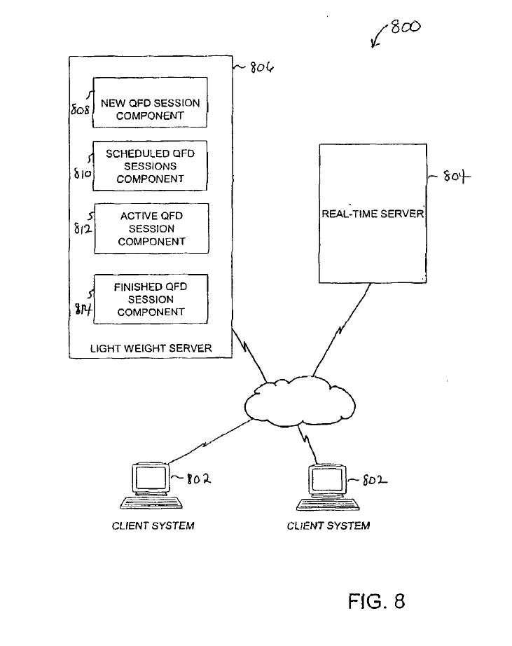

FIG. 8 illustrates a system 800 for implementing the QFD tool. A user at one of client systems 802 logs on to the QFD tool using conventional means, and the real-time server 804 receives the information, verifying the identity and access level of the user. If approved, the server 804 registers the user with the Lightweight thin client server 806 for access to the QFD tool and QFD data. Components of the QFD tool include Create New QFD Session 808, Scheduled QFD Sessions 810, Active QFD Session 812, and Finished QFD Session 814. Upon logging onto the QFD tool, a user is presented with a main menu 300 as illustrated in FIG. 3. Menu options “New QFD” 302, “Active QFD” 304, “Finished QFD” 306, and “Scheduled QFD” 308 are displayed. “New QFD” option 302 corresponds to New QFD Session Component 808 and allows a user to create a new QFD session as described further in FIG. 4. “Active QFD” option 304 corresponds to Active QFD Session 812 component and allows a user to enter a QFD session in progress, provided the user has proper access permissions. This feature is described further herein. “Finished QFD” 306 option corresponds to Finished QFD Session 814 component and allows a user to resurrect an old QFD session. “Scheduled QFD” 308 option corresponds to Schedule QFD Sessions 810 component and allows a user to check a listing of QFD sessions that are currently scheduled by the QFD tool. This listing may provide specific information about the sessions such as a session identifier, the creator of the session, and the date and time of the session.

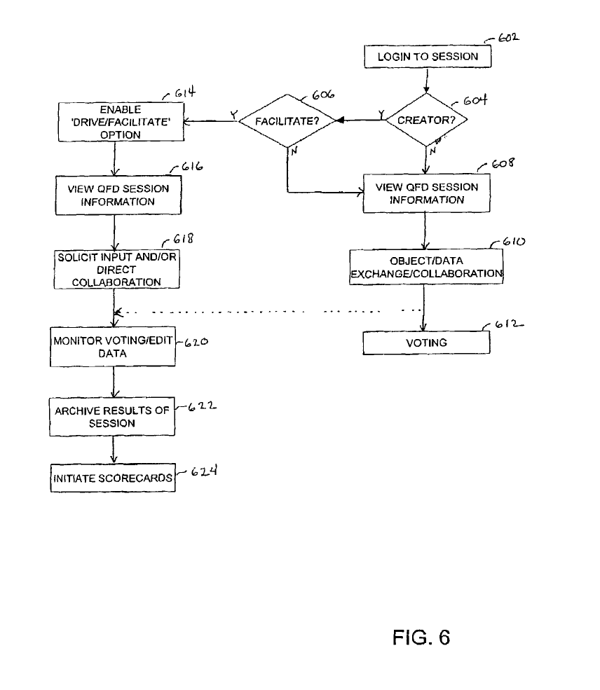

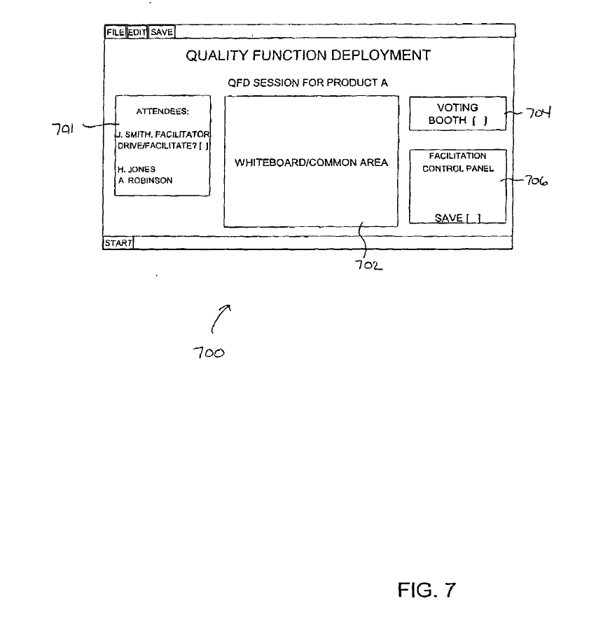

The New QFD Session component 808 will now be described. To create a new QFD session, a user selects New QFD 302 option from main menu 300 screen. The New QFD screen 400 is displayed and the user is prompted to provide information as shown in FIG. 4. Information requested from the user includes a QFD name or identifier 402, a password (if applicable for the QFD) 404, the start time 406 of the QFD session, and the end time 408. Selecting “OK” 410 will cause the QFD session to be created and stored in a computer storage location or memory. The QFD tool later identifies the name of the user who initiated the new QFD as the “creator” of the QFD session as shown and described further in FIGS. 6 and 7.

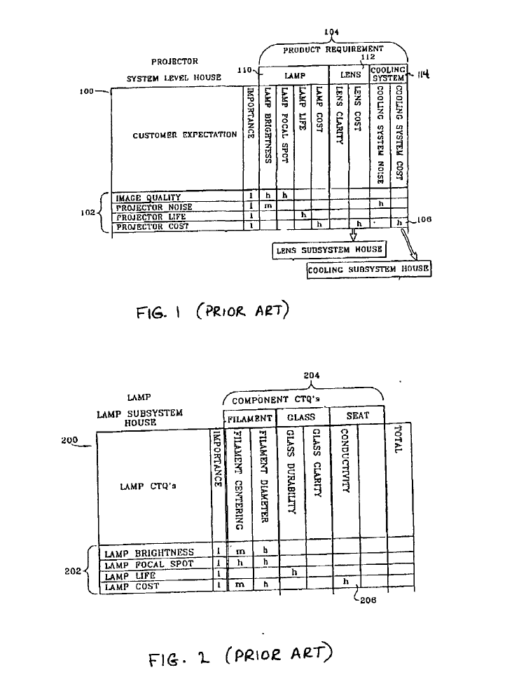

FIG. 6 is a flowchart describing the process of participating in an active session enabled by the Active QFD Session 812 component of the QFD tool in an exemplary embodiment. Upon selecting the “Active QFD” 304 option on main menu 300, the user is presented with a list of active sessions. A sample Active Sessions screen 500 is displayed. Two active sessions are presented on screen 500 and include “Product A” which was created by J. Smith and is scheduled for Dec. 4, 2002 at 8:30 a.m. and “Product B”, created by H. Jones and is scheduled for Dec. 4, 2002 at 8:45 a.m. The Product A and Product B items correspond to the QFD identifiers 402 of FIG. 4. The user logs onto a session at step 602. This may involve entering a password in block 502 if applicable depending on the business rules adopted by the business entity. The tool checks to see if the user entering the session is the ‘creator’ of the session at step 604. A creator is generally the individual who entered the QFD session in the system but may alternatively be an individual selected to be the facilitator of the session. Likewise, the creator and the facilitator may be one and the same person. If the person entering the session is the creator/facilitator for the session, the tool prompts the user to specify whether he/she would like to facilitate the session at step 606. If not, or alternatively, if the user entering the session is not the creator, the tool presents QFD information relating to the session created at step 608. QFD information may include the CTQ attributes and values as well as KCPs and values as shown generally in FIGS. 1 and 2 or may comprise other quality control information desirable. A sample active session and QFD information are shown in Active Session screen 700 of FIG. 7. Users can view an attendee list 701 of those online for the session. The attendee list provides the attendees' names and may also provide additional information such as the attendees' business roles, job titles, business affiliation, and geographic locations to name a few. The session members who have entered the session may exchange data and objects such as applications, files, and documents at step 610. Additionally, data can be in various formats including text, graphics, audio and video. This exchange is performed in a common area or white board 702 on the user's computer screen. Once the collaboration/discussions are completed, the session members select the Voting booth 704 option and vote on QFD data at step 612. The QFD tabulates the votes and revises the quality matrix or QFD session information to reflect the relative importance of the CTQ attributes and values adopted or approved regarding the session subject. Voting may also be repeated by the session members in order to reach a consensus if desirable.

Reverting back to step 606, if the person entering the session decides to facilitate the session, the ‘enable drive/facilitation’ option is activated at step 614. This allows the person to control the session and direct communications among the members in an organized fashion. The facilitator is able to view the QFD session information at step 616 and manage the progress and pace of the session in a controlled manner at step 618. The facilitator has access to a Facilitation control panel 706 component that allows him/her to edit the QFD data, voting methods, and view the activities of the session members at step 620. In the event that the creator of the session has elected not to facilitate, he/she may still access the facilitation control panel (following step 610) as reflected in FIG. 6. The results of the session are archived in a computer storage location at step 622 and scorecards are electronically initiated at step 624. Scorecards contain the key control parameters to be monitored for a given scenario.

Once archived in the scorecards in a data storage location, houses of quality can be drilled down to subsystems. A dashboard indicating the top level CTQs sits on top of the house of quality and is affected by changes in the CTQs of the relative subsystems. Users can define simple functional relationships between what is in the dashboard and the rest of the scorecards. Users can view this dashboard and can add CTQs to that dashboard independent from the QFD or in addition to it.

In an exemplary embodiment, the lightweight server executes an application program to facilitate QFD sessions. The user system may be implemented using a personal computer or a host attached terminal. If the user system is a personal computer, the processing and storage described herein may be shared by the user system and the lightweight server in any manner known in the art (e.g., by providing an applet to the user system).

The network may be any type of known network including a local area network (LAN), a wide area network (WAN), an intranet, or a global network (e.g., Internet). The user systems, data storage devices, same-time server, and lightweight server may be in communication via multiple networks (e.g., intranet and Internet) so that it is not necessary for all user systems and data storage devices to be coupled to the servers through the same network. The user systems, data storage devices and the servers may be connected to the network in a wireless fashion and the network may be a wireless network. In one embodiment, the user system executes a user interface application (e.g., web browser) to contact the servers through the network. It will be understood that multiple servers may be used to implement the real time collaboration server functions, object exchange, and scheduling functions.

The data storage component can be implemented using a variety of devices for storing electronic information such as a file transfer protocol (FTP) server. It is understood that these devices may be implemented using memory contained in the real-time server or user system or that they may be on separate physical devices. The data storage device includes QFD data, session archives, and other similar information. The real time server may also operate as a database server and coordinate access to QFD data on behalf of user systems utilizing replication capabilities or other known methods.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for performing synchronous quality function deployment (QFD) over a computer network, the computer network including a real-time server, a lightweight thin client server, a data storage device, and at least two client systems, the system comprising:
a QFD tool including:
a ‘Create New QFD’ session component;
an ‘Active QFD session’ component;
a ‘Finished QFD session’ component; and
a ‘Scheduled QFD session’ component;
wherein said lightweight thin client server executes said QFD tool and said at least two client systems access said QFD tool in real time via said real-time server.

2. The system of claim 1, wherein said ‘Create New QFD session’ component includes instructions for establishing a new QFD session by a user, said instructions including:
a QFD session identification;
a start time of the QFD session; and
an end time of the QFD session;
wherein further an identification of the user creating the QFD session is associated with the QFD session.

3. The system of claim 1, wherein said ‘Scheduled QFD session’ component includes a listing of QFD sessions that are scheduled, said listing of QFD sessions comprising:
QFD session identifiers;
QFD session creators;
date of said QFD sessions; and
time of said QFD sessions.

4. The system of claim 1, wherein said ‘Finished QFD session’ component enables a user to resurrect a completed QFD session.

5. The system of claim 1, wherein said ‘Active QFD session’ component enables a user to view a listing of QFD sessions in progress.

6. The system of claim 1, wherein said ‘Active QFD session’ component requires password authorization for participating in an active QFD session, and wherein further, by selecting a QFD session in progress, a user enters said QFD session.

7. The system of claim 6, wherein said ‘Active QFD session’ component displays:
a collaborative workspace;
a list of attendees;
a voting booth; and
a facilitation control panel.

8. The system of claim 7, wherein attendees of an active QFD session exchange information in real time, said information including:
critical to quality attributes;
critical to quality values;
key control parameters;
key control parameter values;
interaction weights; and
house of quality data.

9. The system of claim 8, wherein said information is exchanged in at least one of:
audio form;
graphical form;
video form; and
text form.

10. The system of claim 8, wherein said information includes:
documents;
files; and
programs.

11. The system of claim 7, wherein said voting booth includes instructions for selecting and prioritizing said information exchanged in said active QFD session.

12. The system of claim 7, wherein said list of attendees includes attendee information including:
name of attendee;
role of attendee;
job title of attendee;
business affiliation of attendee; and
geographical location of attendee.

13. The system of claim 12, wherein said role of attendee includes at least one of:
a session facilitator;
a session creator; and
a team member.

14. The system of claim 7, wherein said facilitation control panel enables a session facilitator superior access to active QFD session activities, said superior access including:
view voting booth activities;
override voting booth activities;
approve voting booth activities and voting results;
edit said information exchanged in said collaborative workspace; and
approve access to active QFD sessions.

15. A method for performing synchronous quality function deployment (QFD) over a computer network, the computer network including a real-time server, a light-weight thin client server, a data storage device, and at least two client systems, the method comprising:
receiving a request to participate in an active QFD session;
presenting a list of active QFD sessions;
providing access to a selected active QFD session including:
presenting QFD session information relating to said active QFD session;
providing a common area operable for facilitating collaboration among session members via computer screens of said at least two client systems;
upon completion of said collaboration, presenting a voting booth option;
receiving votes from said session members relating to said QFD information via said voting booth option; and
tabulating said votes;
updating QFD session information in said data storage device to reflect results of said collaboration; and
electronically generating scorecards.

16. The method of claim 15, further comprising a facilitation control panel option operable for allowing a facilitator of said active QFD session to control said active QFD session and direct communications among said session members.

17. The method of claim 15, wherein said QFD session information includes at least one of:
an attendee list of session members online for said active QFD session;
critical to quality (CTQ) attributes;
CTQ values;
key control parameters (KCPs);
KCP values; and
a facilitator of said active QFD session.

18. The method of claim 17, wherein said attendee list includes at least one of:
attendee names;
attendee business roles;
attendee job titles;
attendee business affiliation; and
attendee geographic location.

19. The method of claim 15, wherein said collaboration includes exchanging information among said session members, said information including at least one of:
applications;
files; and
documents.

20. The method of claim 19, wherein said information is exchanged in a formatting including at least one of:
text;
graphics;
audio; and
video.

21. The method of claim 17, wherein said updating said QFD information includes updating said QFD information to reflect the relative importance of CTQ attributes and CTQ values adopted or approved during said active QFD session.

22. The method of claim 15, wherein said providing access to said active QFD session includes verifying whether a person requesting access to said active QFD session is at least one of:
a creator of said active QFD session; and
a facilitator of said active QFD session;
wherein said creator or said facilitator is prompted to choose whether or not to facilitate said active QFD session.

23. The method of claim 22, wherein said facilitator is given access to a facilitation control panel operable for:
editing said QFD session information;
editing voting methods provided via said voting booth option;
viewing activities conducted by said session members.

24. The method of claim 15, wherein said scorecards contain key control parameters to be monitored for a given scenario.

25. The method of claim 24, wherein houses of quality for said scorecards are drilled down to subsystems.

26. The method of claim 25, wherein a dashboard sits on top of said house of quality and is affected by changes in CTQs of said subsystems, said dashboard indicating top level CTQs.

27. A storage medium encoded with machine-readable computer program code for performing synchronous quality function deployment (QFD) over a computer network, the computer network including a real-time server, a light-weight thin client server, a data storage device, and at least two client systems, the storage medium including instructions for causing said computer network to implement a method comprising:
receiving a request to participate in an active QFD session;
presenting a list of active QFD sessions;
providing access to a selected active QFD session including:
presenting QFD session information relating to said active QFD session;
providing a common area operable for facilitating collaboration among session members via computer screens of said at least two client systems;
upon completion of said collaboration, presenting a voting booth option;
receiving votes from said session members relating to said QFD information via said voting booth option; and
tabulating said votes;
updating QFD session information in said data storage device to reflect results of said collaboration; and
electronically generating scorecards.

28. The storage medium of claim 27, further comprising instructions for causing said computer network to implement:
a facilitation control panel option operable for allowing a facilitator of said active QFD session to control said active QFD session and direct communications among said session members.

29. The storage medium of claim 27, wherein said QFD session information includes at least one of:
an attendee list of session members online for said active QFD session;
critical to quality (CTQ) attributes;
CTQ values;
key control parameters (KCPs);
KCP values; and
a facilitator of said active QFD session.

30. The storage medium of claim 29, wherein said attendee list includes at least one of:
attendee names;
attendee business roles;
attendee job titles;
attendee business affiliation; and
attendee geographic location.

31. The storage medium of claim 27, wherein said collaboration includes exchanging information among said session members, said information including at least one of:
applications;
files; and
documents.

32. The storage medium of claim 31, wherein said information is exchanged in a formatting including at least one of:
text;
graphics;
audio; and
video.

33. The storage medium of claim 29, wherein said updating said QFD information includes updating said QFD information to reflect the relative importance of CTQ attributes and CTQ values adopted or approved during said active QFD session.

34. The storage medium of claim 27, wherein said providing access to said active QFD session includes verifying whether a person requesting access to said active QFD session is at least one of:
a creator of said active QFD session; and
a facilitator of said active QFD session;
wherein said creator or said facilitator is prompted to choose whether or not to facilitate said active QFD session.

35. The storage medium of claim 34, wherein said facilitator is given access to a facilitation control panel operable for:
editing said QFD session information;
editing voting methods provided via said voting booth option;
viewing activities conducted by said session members.

36. The storage medium of claim 27, wherein said scorecards contain key control parameters to be monitored for a given scenario.

37. The storage medium of claim 36, wherein houses of quality for said scorecards are drilled down to subsystems.

38. The storage medium of claim 37, wherein a dashboard sits on top of said house of quality and is affected by changes in CTQs of said subsystems, said dashboard indicating top level CTQs.
